(19) United States
(12) Patent Application Publication
(10) Pub. No.: US 2026/0317957 A1
(43) Pub. Date: Oct. 15, 2026

(54) FIBER AND NONWOVEN FABRIC

(71) Applicant: KANEKA CORPORATION, Osaka (JP)

(72) Inventor: Yurina Ino, Osaka (JP)

(73) Assignee: KANEKA CORPORATION, Osaka (JP)

(21) Appl. No.: 19/649,495

(22) Filed: Apr. 16, 2026

Related U.S. Application Data
(63) Continuation of application No. PCT/JP2024/036272, filed on Oct. 10, 2024.

(30) Foreign Application Priority Data
Oct. 25, 2023 (JP) 2023-183087

(51) Int. Cl. D01F 8/14; C08L 67/04; D04H 1/435; D04H 1/4382

(52) U.S. Cl. CPC D01F 8/14; C08L 67/04; D04H 1/435; D04H 1/43828; C08L 2203/12; D10B 2331/041; D10B 2401/12

(57) ABSTRACT

A poly(3-hydroxyalkanoate) resin-containing fiber is provided. The poly(3-hydroxyalkanoate) resin includes a 3-hydroxybutyrate unit. The fiber is suppressed from fusing during production of the fiber and is thermally fusible at low temperatures during thermal processing of the fiber. The fiber includes a core-sheath structure including a core portion and a sheath portion. Each of the core portion and the sheath portion contains the poly(3-hydroxyalkanoate) resin including the 3-hydroxybutyrate unit. An average molar content of the 3-hydroxybutyrate unit in the poly(3-hydroxyalkanoate) resin of the core portion is greater than an average molar content of the 3-hydroxybutyrate unit in the poly(3-hydroxyalkanoate) resin of the sheath portion.

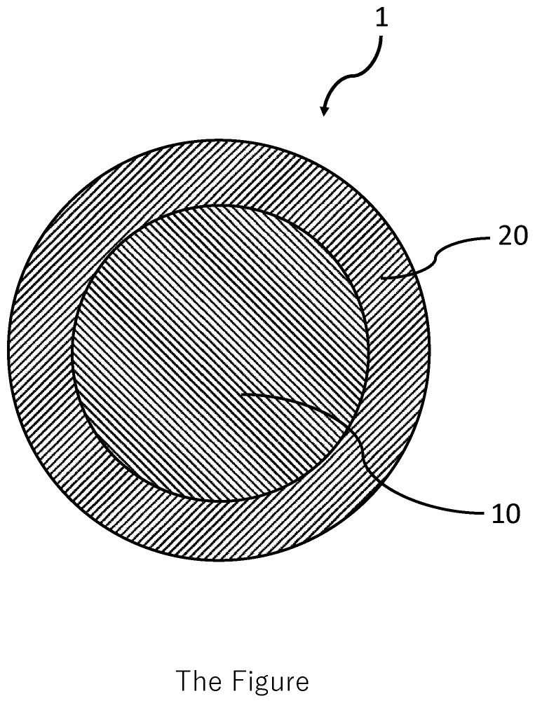

### TECHNICAL FIELD

One or more embodiments of the present invention relate to fibers and nonwoven fabrics.

### BACKGROUND

In recent years, plastic wastes have been causing heavy burdens on the global environment, such as harmful effects on ecosystems, generation of harmful gas during combustion of the plastic wastes, and global warming due to a large amount of heat generated by the combustion of the plastic wastes. Biodegradable plastics are considered as materials that can address the above, and the development of biodegradable plastics has been actively ongoing.

Among such biodegradable plastics, carbon dioxide that is generated when a biodegradable plastic obtained using a plant-derived raw material is combusted originally exists in the air. Therefore, combusting such a biodegradable plastic does not cause an increase in carbon dioxide in the atmosphere. This is called carbon neutrality. Importance is given to carbon neutrality under the Kyoto Protocol, which specifies carbon dioxide reduction goals, and active use of biodegradable plastics obtained using plant-derived raw materials is desired.

Nowadays, from the viewpoints of biodegradability and carbon neutrality, aliphatic polyester resins are attracting attention as biodegradable plastics that are microbially produced using plant-derived raw materials as carbon sources. Attention has been directed particularly to polyhydroxyalkanoate resins.

Patent Literature 1 discloses a microorganism-degradable conjugated fiber including: a poly(β-hydroxyalkanoate) or a copolymer thereof as a core component; and poly-ε-caprolactone and/or poly-β-propiolactone as a sheath component.

Patent Literature 2 discloses a foamed fibrillated molded article including the following copolymer (A) and copolymer (B).
(A) a copolymer including the following structural units (a1) and (a2) in a ratio specified below (with the total of (a1) and (a2) being 100 mol %)
(a1) a 3-hydroxybutyrate structural unit
   from 92 mol % to 98 mol %
(a2) a structural unit represented by [—O—R1-CO-]
   from 2 mol % to 8 mol %

(R1 represents a straight-chain or branched-chain alkyl group having 3 to 17 carbon atoms.)

(It should be noted that the structural unit (a2) includes no 3-hydroxybutyrate structural unit.)
(B) a copolymer including the following structural units (b1) and (b2) in a ratio specified below (with the total of (b1) and (b2) being 100 mol %)
   (b1) a 3-hydroxybutyrate structural unit
      85 mol % or greater and less than 92 mol %
   (b2) a structural unit represented by [—O—R2-CO—]
      greater than 8 mol % and less than or equal to 15 mol %

(R2 represents a straight-chain or branched-chain alkyl group having 3 to 17 carbon atoms.)

(It should be noted that the structural unit (b2) includes no 3-hydroxybutyrate structural unit.)

### PATENT LITERATURE

PTL 1: Japanese Laid-Open Patent Application Publication No. H05-93318
PTL 2: Japanese Laid-Open Patent Application Publication No. 2023-49669

Incidentally, conventional fibers may undergo fusion during their production, or may fail to sufficiently fuse thermally at low temperatures during their thermal processing, making the thermal processing difficult.

### SUMMARY

In view of the above, one or more embodiments of the present invention are to provide a poly(3-hydroxyalkanoate) resin-containing fiber in which the poly(3-hydroxyalkanoate) resin includes a 3-hydroxybutyrate unit, the fiber being suppressed from fusing during production of the fiber and being thermally fusible at low temperatures during thermal processing of the fiber, and to provide a nonwoven fabric including the fiber.

One or more embodiments of the present invention relate to a fiber including a core-sheath structure including a core portion and a sheath portion, wherein: each of the core portion and the sheath portion contains a poly(3-hydroxyalkanoate) resin including a 3-hydroxybutyrate unit; and an average molar content of the 3-hydroxybutyrate unit in the poly(3-hydroxyalkanoate) resin of the core portion is greater than an average molar content of the 3-hydroxybutyrate unit in the poly(3-hydroxyalkanoate) resin of the sheath portion.

One or more embodiments of the present invention also relate to a method for producing a fiber, the method including melt-spinning a raw material composition for the core portion and a raw material composition for the sheath portion by using a core-sheath composite spinning nozzle to obtain the fiber.

One or more embodiments of the present invention further relate to a nonwoven fabric including the fiber.

One or more embodiments of the present invention make it possible to provide a poly(3-hydroxyalkanoate) resin-containing fiber in which the poly(3-hydroxyalkanoate) resin includes a 3-hydroxybutyrate unit, the fiber being suppressed from fusing during production of the fiber and being thermally fusible at low temperatures during thermal processing of the fiber, and to provide a nonwoven fabric including the fiber.

### BRIEF DESCRIPTION OF THE DRAWING

The FIGURE is a schematic diagram showing a cross section of a single filament that is a fiber according to one or more embodiments of the present invention.

### DETAILED DESCRIPTION

Hereinafter, one or more embodiments of the present invention are described with reference to the accompanying drawing.

### <Fiber According to One or More Embodiments>

A fiber according to one or more embodiments includes a core-sheath structure including a core portion and a sheath portion.

Each of the core portion and the sheath portion contains a poly(3-hydroxyalkanoate) resin including a 3-hydroxybutyrate unit (which is hereinafter also referred to as “P3HA resin”, “P3HA”, “poly(3-hydroxybutyrate) resin”, or “P3HB resin”).

The average molar content of the 3-hydroxybutyrate unit in the poly(3-hydroxyalkanoate) resin of the core portion is greater than the average molar content of the 3-hydroxybutyrate unit in the poly(3-hydroxyalkanoate) resin of the sheath portion.

By having the above configuration, the fiber according to one or more embodiments is a poly(3-hydroxyalkanoate) resin-containing fiber that is suppressed from fusing during its production and that is thermally fusible at low temperatures during its thermal processing.

The fiber according to one or more embodiments may be a multifilament including a plurality of single filaments or may be a monofilament that is a single filament. However, the fiber may be a multifilament since a multifilament is flexible, soft, and usable for a nonwoven fabric or the like.

The single filament is a core-sheath conjugated fiber.

The FIGURE is a schematic diagram showing a cross section of a single filament 1, which is a core-sheath conjugated fiber as the fiber according to one or more embodiments (the cross section is taken perpendicularly to the longitudinal direction of the single filament).

As shown in the Figure, the single filament 1, which is a core-sheath conjugated fiber, includes a core portion 10 and a sheath portion 20. In the cross section of the core-sheath conjugated fiber (the cross section perpendicular to the longitudinal direction of the core-sheath conjugated fiber), preferably, the core portion is present inside the sheath portion. The core-sheath conjugated fiber may have, in the cross section (the cross section perpendicular to the longitudinal direction of the core-sheath conjugated fiber), a concentric structure in which the center position of the core portion coincides with the center position of the core-sheath conjugated fiber, or an eccentric structure in which the center position of the core portion does not coincide, i.e., eccentric, with the center position of the core-sheath conjugated fiber.

The sectional shape of the single filament 1, which is a core-sheath conjugated fiber, and that of the core portion 10 are not particularly limited. The sectional shape may be, for example, a circular shape or a non-circular shape. Examples of the non-circular shape include an ellipsoidal shape, an intersecting circular shape, a cocoon shape, a dumbbell shape, a dog-bone shape, and a ribbon shape. The sectional shape of the core-sheath conjugated fiber and the sectional shape of the core portion may be the same (or similar to each other), or may be different from each other.

In one or more embodiments, the major-axis direction of the cross section of the single filament and the major-axis direction of the cross section of the core portion coincide with each other.

In the embodiment shown in the Figure, both the sectional shape of the single filament 1, which is a core-sheath conjugated fiber, and the sectional shape of the core portion 10 are circular, and the core portion 10 is disposed concentrically with the single filament 1, which is a core-sheath conjugated fiber.

The sectional shape of the single filament, which is a core-sheath conjugated fiber, and the sectional shape of the core portion can be controlled, when fabricating the fiber with a below-described core-sheath composite spinning nozzle, by using the core-sheath composite spinning nozzle that has nozzle holes with shapes close to intended sectional shapes.

In the cross section of the fiber according to one or more embodiments (the cross section perpendicular to the longitudinal direction of the fiber, i.e., the cross section perpendicular to the longitudinal direction of the single filament), the core-sheath ratio (the ratio between the core portion 10 and the sheath portion 20) is not particularly limited. From the viewpoint of achieving a complex appearance, spinning, cross-sectional stability, etc., the area ratio between the core portion 10 and the sheath portion 20 may be in a range from 1:9 to 9:1, from 2:8 to 8:2, or from 3:7 to 7:3.

In other words, in the cross section of the fiber, the area ratio of the core portion 10 to the sheath portion 20 may be such that the core portion/the sheath portion is from 9/1 to 1/9, the core portion/the sheath portion is from 8/2 to 2/8, or the core portion/the sheath portion is from 7/3 to 3/7.

The core-sheath ratio can be determined by a method described below in Examples.

The fiber according to one or more embodiments contains a polymer component.

The polymer component contains a poly(3-hydroxyalkanoate) resin including a 3-hydroxybutyrate unit.

The polymer component may contain another polymer in addition to the poly(3-hydroxyalkanoate) resin.

The poly(3-hydroxyalkanoate) resin is a biodegradable polymer.

It should be noted that being “biodegradable” in the present disclosure means being able to be decomposed into low molecular weight compounds by microorganisms in a natural environment. Being biodegradable or not can be determined based on tests suited for different environments. Specifically, for example, ISO 14855 (compost) and ISO 14851 (activated sludge) are suited for an aerobic condition, and ISO 14853 (aqueous phase) and ISO 15985 (solid phase) are suited for an anaerobic condition. Also, biodegradability by microorganisms in seawater can be evaluated by biochemical oxygen demand measurement.

The poly(3-hydroxyalkanoate) resin is a concept that includes a homopolymer and a copolymer.

The poly(3-hydroxyalkanoate) resin may be a copolymer.

Examples of the poly(3-hydroxyalkanoate) resin include P3HB, P3HB3HH, P3HB3HV, P3HB4HB, poly(3-hydroxybutyrate-co-3-hydroxyoctanoate), and poly(3-hydroxybutyrate-co-3-hydroxyoctadecanoate).

P3HB herein means poly(3-hydroxybutyrate) as a homopolymer.

P3HB3HH herein means poly(3-hydroxybutyrate-co-3-hydroxyhexanoate), which may also be referred to as a (3-hydroxybutyrate-co-3-hydroxyhexanoate) copolymer resin.

P3HB3HV herein means poly(3-hydroxybutyrate-co-3-hydroxyvalerate).

P3HB4HB herein means poly(3-hydroxybutyrate-co-4-hydroxybutyrate).

It should be noted that P3HB has a function to facilitate crystallization of P3HB itself and crystallization of the poly(3-hydroxyalkanoate) resin other than P3HB. Accordingly, preferably, the poly(3-hydroxyalkanoate) resin includes P3HB.

From the viewpoint of achieving both excellent biodegradability and excellent molding processability, the poly(3-hydroxyalkanoate) resin may be, but is not particularly limited to, P3HB, P3HB3HH, P3HB3HV, or P3HB4HB.

Further, from the viewpoints of increasing the strength of the fiber according to one or more embodiments and increasing the molding processability, the poly(3-hydroxyalkanoate) resin may be poly(3-hydroxybutyrate-co-3-hydroxyhexanoate) (P3HB3HH).

The average molar content of the 3-hydroxybutyrate unit in the poly(3-hydroxyalkanoate) resin of the core portion is greater than the average molar content of the 3-hydroxybutyrate unit in the poly(3-hydroxyalkanoate) resin of the sheath portion.

In the present application, the “average molar content of the 3-hydroxybutyrate unit in the poly(3-hydroxyalkanoate) resin” is also referred to as the “average molar content of 3HB in the P3HA resin”.

From the viewpoints of further suppressing fusion during production of the fiber and enabling thermal fusion of the fiber at lower temperatures during thermal processing of the fiber, the value of a difference between the average molar content of 3HB in the P3HA resin of the core portion and the average molar content of 3HB in the P3HA resin of the sheath portion may be from 0.2 to 9.0 mol %, from 0.4 to 7.0 mol %, from 0.5 to 4.5 mol %, from 1.0 to 4.0 mol %, or from 1.5 to 3.5 mol %.

It should be noted that the value of the difference between the average molar content of 3HB in the P3HA resin of the core portion and the average molar content of 3HB in the P3HA resin of the sheath portion is obtained by subtracting the average molar content of 3HB in the P3HA resin of the sheath portion from the average molar content of 3HB in the P3HA resin of the core portion.

As a result of the average molar content of the 3-hydroxybutyrate unit in the poly(3-hydroxyalkanoate) resin of the core portion being greater than the average molar content of the 3-hydroxybutyrate unit in the poly(3-hydroxyalkanoate) resin of the sheath portion, the fiber according to one or more embodiments can suppress fusion of the fiber during production of the fiber and is thermally fusible at low temperatures during thermal processing of the fiber.

From the viewpoints of further suppressing fusion during production of the fiber and enabling thermal fusion of the fiber at lower temperatures during thermal processing of the fiber, the fiber according to one or more embodiments may include: a copolymer (A) in which the molar ratio of monomers of the 3-hydroxybutyrate unit to monomers of another hydroxyalkanoate unit is such that the 3-hydroxybutyrate unit/the other hydroxyalkanoate unit=from 99/1 to 93/7; and a copolymer (B) in which the molar ratio of monomers of the 3-hydroxybutyrate unit to monomers of another hydroxyalkanoate unit is such that the 3-hydroxybutyrate unit/the other hydroxyalkanoate unit=from 92/8 to 76/24.

In the copolymer (A), the molar ratio of monomers of the 3-hydroxybutyrate unit to monomers of the other hydroxyalkanoate unit may be such that the 3-hydroxybutyrate unit/the other hydroxyalkanoate unit is from 99/1 to 93/7, from 98/2 to 93/7, or from 97/3 to 93/7.

In the copolymer (B), the molar ratio of monomers of the 3-hydroxybutyrate unit to monomers of the other hydroxyalkanoate unit may be such that the 3-hydroxybutyrate unit/the other hydroxyalkanoate unit is from 92/8 to 76/24, from 91/9 to 80/20, or from 90/10 to 85/15.

The average molar content of the 3-hydroxybutyrate unit in the poly(3-hydroxyalkanoate) resin, and the molar ratio of monomers of the 3-hydroxybutyrate unit to monomers of the other hydroxyalkanoate unit (the 3-hydroxybutyrate unit/the other hydroxyalkanoate unit) in the poly(3-hydroxyalkanoate) resin, can each be determined by a method described below.

First, 2 mL of a mixed solution of sulfuric acid and methanol (the volume of sulfuric acid: the volume of methanol=15:85) and 2 mL of chloroform are added to 20 mg of the P3HA resin in a dry state. The resulting sample is placed in a container, and the container is sealed. The sample in the sealed container is heated at 100° C. for 140 minutes, and thereby a first reaction solution is obtained, the first reaction solution including a methyl ester that is a P3HA resin degradation product.

Then, the first reaction solution is cooled, and 1.5 g of sodium hydrogen carbonate is added to the cooled first reaction solution little by little for neutralization. The resulting mixture is left to stand until generation of carbon dioxide stops. In this manner, a second reaction solution is obtained.

Further, 4 mL of diisopropyl ether is added to and mixed well with the second reaction solution, and thereby a mixture is obtained.

Next, the mixture is subjected to centrifugal separation, and thereby a supernatant solution is obtained.

Then, the average molar content of the 3-hydroxybutyrate unit in the poly(3-hydroxyalkanoate) resin, and the molar ratio of monomers of the 3-hydroxybutyrate unit to monomers of the other hydroxyalkanoate unit (the 3-hydroxybutyrate unit/the other hydroxyalkanoate unit) in the poly(3-hydroxyalkanoate) resin, can be determined by analyzing the monomer unit composition of the aforementioned degradation product in the supernatant by capillary gas chromatography under the conditions indicated below.
Gas chromatograph: GC-17A available from Shimadzu Corporation
Capillary column: NEUTRA BOND-1 (column length: 25 m, column inner diameter: 0.25 mm, liquid film thickness: 0.4 μm) available from GL Sciences Inc.
Carrier gas: He
Column inlet pressure: 100 kPa
Sample amount: 1 μL

From the viewpoints of further suppressing fusion during production of the fiber and enabling thermal fusion of the fiber at lower temperatures during thermal processing of the fiber, the content of the copolymer (B) in the fiber according to one or more embodiments may be from 5 to 40% by weight, from 10 to 35% by weight, or from 12 to 30% by weight, per 100% by weight of the poly(3-hydroxyalkanoate) resin.

From the viewpoint of enabling thermal fusion of the fiber at lower temperatures during thermal processing of the fiber, the sheath portion may include the copolymer (B).

From the viewpoints of further suppressing fusion during production of the fiber and enabling thermal fusion of the fiber at lower temperatures during thermal processing of the fiber, the sheath portion may include the copolymer (A) and the copolymer (B).

From the viewpoint of further suppressing fusion during production of the fiber, the core portion may include the copolymer (A).

The fiber according to one or more embodiments may contain the poly(3-hydroxyalkanoate) resin in an amount of 50% by weight or greater, 80% by weight or greater, or 90% by weight or greater.

The fiber according to one or more embodiments may further contain the copolymer (A) and the copolymer (B) in an amount of 50% by weight or greater, 80% by weight or greater, or 90% by weight or greater.

The aforementioned another polymer may be biodegradable.

Examples of this other polymer that is biodegradable include polycaprolactone, polylactic acid, polybutylene succinate, polybutylene succinate adipate, polybutylene adipate terephthalate, polyethylene succinate, polyvinyl alcohol, polyglycolic acid, unmodified starch, modified starch, cellulose acetate, chitosan, and poly(4-hydroxyalkanoate) resin.

The polycaprolactone is a polymer obtained by ring-opening polymerization of ε-caprolactone.

The polymer component may include one kind of this other polymer, or two or more kinds of these other polymers.

Since the fiber according to one or more embodiments includes the biodegradable polymer(s), even if the fiber is discarded in an environment, since the fiber is readily decomposed in the environment, the load on the environment can be reduced.

The fiber according to one or more embodiments may further contain an additive.

Examples of the additive include a crystal nucleating agent, a lubricant, a plasticizer, a spinning oil, a stabilizer (such as an oxidation inhibitor or ultraviolet absorber), a colorant (such as a dye or pigment), an inorganic filler, an organic filler, and an antistatic agent.

In order to facilitate the crystallization of the poly(3-hydroxyalkanoate) resin, the fiber according to one or more embodiments may contain a crystal nucleating agent.

The crystal nucleating agent is a compound that has an effect of facilitating the crystallization of the poly(3-hydroxyalkanoate) resin. The crystal nucleating agent has a melting point higher than that of the poly(3-hydroxyalkanoate) resin.

Examples of the crystal nucleating agent include: inorganic substances (e.g., boron nitride, titanium oxide, talc, layered silicate, calcium carbonate, sodium chloride, metal phosphate, etc.); sugar alcohol compounds derived from natural products (e.g., pentaerythritol, erythritol, galactitol, mannitol, arabitol, etc.); polyvinyl alcohol; chitin; chitosan; polyethylene oxides; aliphatic carboxylates; aliphatic alcohols; aliphatic carboxylic acid esters; dicarboxylic acid derivatives (dimethyl adipate, dibutyl adipate, di-isodecyl adipate, and dibutyl sebacate); cyclic compounds having, in their molecule, C—O and a functional group selected from the group consisting of NH, S, and O (e.g., indigo, quinacridone, quinacridone magenta, etc.); sorbitol derivatives (e.g., bis-benzylidene sorbitol, bis(p-methylbenzylidene) sorbitol, etc.); compounds including a nitrogen-containing heteroaromatic nucleus (e.g., pyridine ring, triazine ring, imidazole ring, etc.) (e.g., pyridine, triazine, imidazole, etc.); phosphate ester compounds; bisamides of higher fatty acids; metal salts of higher fatty acids; and branched polylactic acid.

It should be noted that P3HB, which is the poly(3-hydroxyalkanoate) resin, can be used as the crystal nucleating agent.

One of these crystal nucleating agents may be used alone, or two or more of these crystal nucleating agents may be used in combination.

As the crystal nucleating agent, sugar alcohol compounds, polyvinyl alcohol, chitin, and chitosan are preferable in light of the effect of improving the crystallization rate of the poly(3-hydroxyalkanoate) resin as well as in light of compatibility and affinity with the poly(3-hydroxyalkanoate) resin.

Among the sugar alcohol compounds, pentaerythritol is preferable.

The crystal nucleating agent may have a crystal structure at normal temperature (25° C.).

Since the crystal nucleating agent has a crystal structure at normal temperature (25° C.), the crystallization of the poly(3-hydroxyalkanoate) resin is further facilitated, which is advantageous.

The crystal nucleating agent that has a crystal structure at normal temperature (25° C.) may be powdery at normal temperature (25° C.).

The crystal nucleating agent that is powdery at normal temperature (25° C.) may have a mean particle diameter of 10 μm or less.

The content of the crystal nucleating agent in the fiber according to one or more embodiments may be 0.05 parts by weight or greater, 0.1 parts by weight or greater, or 0.5 parts by weight or greater, per 100 parts by weight of the poly(3-hydroxyalkanoate) resin. As a result of the content of the crystal nucleating agent in the fiber according to one or more embodiments being 0.05 parts by weight or greater per 100 parts by weight of the poly(3-hydroxyalkanoate) resin, the crystallization of the poly(3-hydroxyalkanoate) resin can be further facilitated, which is advantageous.

Further, the content of the crystal nucleating agent in the fiber according to one or more embodiments may be 10 parts by weight or less, 8 parts by weight or less, or 5 parts by weight or less, per 100 parts by weight of the poly(3-hydroxyalkanoate) resin. As a result of the content of the crystal nucleating agent in the fiber according to one or more embodiments being 10 parts by weight or less per 100 parts by weight of the poly(3-hydroxyalkanoate) resin, the viscosity of a molten material when fabricating the fiber from the molten material by a below-described melt spinning technique can be reduced, which consequently makes it possible to readily fabricate the fiber, which is advantageous.

It should be noted that P3HB is the poly(3-hydroxyalkanoate) resin, and can also function as the crystal nucleating agent. Therefore, in a case where the fiber contains P3HB, the amount of the P3HB is included in both the amount of the poly(3-hydroxyalkanoate) resin and the amount of the crystal nucleating agent.

The fiber according to one or more embodiments may further contain a lubricant.

The lubricant is, for example, a compound having an amide bond.

The compound having an amide bond may include at least one selected from the group consisting of lauric acid amide, myristic acid amide, stearic acid amide, behenic acid amide, and erucic acid amide.

The content of the lubricant in the fiber according to one or more embodiments may be 0.05 parts by weight or greater, 0.1 parts by weight or greater, or 0.5 parts by weight or greater, per 100 parts by weight of the poly(3-hydroxyalkanoate) resin. As a result of the content of the lubricant in the fiber according to one or more embodiments being 0.05 parts by weight or greater per 100 parts by weight of the poly(3-hydroxyalkanoate) resin, the single filament has excellent slipperiness, which is advantageous.

Further, the content of the lubricant in the fiber according to one or more embodiments may be 12 parts by weight or less, 10 parts by weight or less, ever 8 parts by weight or less, or 5 parts by weight or less, per 100 parts by weight of the poly(3-hydroxyalkanoate) resin. As a result of the content of the lubricant in the fiber according to one or more embodiments being 12 parts by weight or less per 100 parts by weight of the poly(3-hydroxyalkanoate) resin, the lubricant can be advantageously suppressed from bleeding out on the surface of the fiber.

The single filament fineness of the fiber according to one or more embodiments may be from 1 to 15 dtex, from 2 to 13 dtex, or from 3 to 12 dtex

As a result of the single filament fineness being 15 dtex or less, the fiber according to one or more embodiments has an advantage in that the fiber can be used for various applications. For example, the fiber according to one or more embodiments can be used as a material for fabricating a spun yarn.

As a result of the single filament fineness being 1 dtex or greater, the fiber according to one or more embodiments has an advantage of increased strength.

It should be noted that in a case where the fiber according to one or more embodiments is a multifilament, the single filament fineness of the fiber means an average value of the fineness of the single filaments included in the fiber.

In a case where the fiber according to one or more embodiments is a monofilament, the single filament fineness of the fiber means the fineness of the fiber itself.

The single filament fineness can be measured by a method described below in Examples.

In a case where the fiber according to one or more embodiments is a multifilament including a plurality of single filaments, the number of single filaments included in the multifilament may be 30 or greater, from 30 to 300,000, or from 50 to 300,000.

The weight-average molecular weight of the fiber according to one or more embodiments may be from 2.0×10⁵ to 6.0×10⁵, or from 2.3×10⁵ to 4.0×10⁵, from the viewpoint of achieving excellent processability when processing the fiber to obtain a processed product.

It should be noted that the weight-average molecular weight in one or more embodiments is measured based on a molecular weight distribution in terms of polystyrene by using gel permeation chromatography (GPC) using a chloroform eluent. A column used in the GPC may be any column suitable for measuring the molecular weight.

For example, the weight-average molecular weight in one or more embodiments can be measured under the conditions indicated below.
Measurement equipment: SHIMADZU 20A available from Shimadzu Corporation
Column: ShodexK-806M available from Showa Denko K. K.
Detector: RI detector
Reference material: polystyrene
Eluent: chloroform (HPLC grade)
Flow rate: 1 mL/min
Temperature: 40° C.

The fiber according to one or more embodiments may be used in the form of a yarn.

The fiber may be cut to obtain a staple having a length of 20 cm or less. The staple may be used in the form of a yarn.

The fibers and/or the staples may be used to fabricate a fibrous product (a fibrous body).

The fibrous product can be made into various shapes (e.g., made into a nonwoven fabric).

The fiber, the staple, and the fibrous product can be suitably used for conventionally known applications.

The fiber, the staple, and the fibrous product can be suitably used in the fields of, for example, agriculture (e.g., horticulture), fishery, forestry, medical care, and food industry.

Examples of the fibrous product include clothes, curtains, carpets, bags, shoes, wiping materials, sanitary items, automobile parts, building materials, and filtration materials (filters).

### <Nonwoven Fabric According to Present Embodiment>

A nonwoven fabric according to one or more embodiments includes the fiber according to one or more embodiments.

Examples of the nonwoven fabric according to one or more embodiments include a thermally bonded nonwoven fabric, a needle-punched nonwoven fabric, a chemically bonded nonwoven fabric, an airlaid nonwoven fabric, and a wet-laid nonwoven fabric.

The fiber according to one or more embodiments is suitably used for fabricating a thermally bonded nonwoven fabric since the fiber according to one or more embodiments enables thermal fusion of the fiber at low temperatures during thermal processing of the fiber.

### <Method for Producing Fiber According to Present Embodiment>

A method for producing the fiber according to one or more embodiments includes melt-spinning a raw material composition for the core portion and a raw material composition for the sheath portion by using a core-sheath composite spinning nozzle to obtain the fiber.

For example, the method for producing the fiber according to one or more embodiments includes: a spinning step of, by a melt spinning technique, melting the raw material compositions to obtain molten materials and spinning the molten materials to obtain undrawn filaments; and a drawing step of drawing the undrawn filaments.

The raw material compositions include the raw material composition for the core portion and the raw material composition for the sheath portion separately.

Each raw material composition includes the poly(3-hydroxyalkanoate) resin.

The weight-average molecular weight of the poly(3-hydroxyalkanoate) resin in each raw material composition may be from 3.0×10⁵ to 7.0×10⁵, from 3.5×10⁵ to 7.0×10⁵, from 4.0×10⁵ to 7.0×10⁵, or from 4.5×10⁵ to 6.5×10⁵.

As a result of the weight-average molecular weight of the poly(3-hydroxyalkanoate) resin in the raw material composition being 3.0×10⁵ or greater, the weight-average molecular weight of the poly(3-hydroxyalkanoate) resin in the fiber can be readily increased, which consequently makes it possible to readily increase the strength of the fiber.

As a result of the weight-average molecular weight of the poly(3-hydroxyalkanoate) resin in the raw material composition being 7.0×10⁵ or less, the forming of the fiber can be readily performed.

In the spinning step, the raw material composition for the core portion is fed to an extruder for the core portion, and the raw material composition for the sheath portion is fed to an extruder for the sheath portion. Then, the raw material composition for the core portion and the raw material composition for the sheath portion are melted to obtain a molten material for the core portion and a molten material for the sheath portion.

Thereafter, the molten material for the core portion and the molten material for the sheath portion are each extruded through the core-sheath composite spinning nozzle and wound onto a winding roll unit to obtain one or more undrawn filaments.

In the drawing step, the obtained one or more undrawn filaments are hauled off by a haul-off roll unit from the winding roll unit, then drawn by a drawing roll unit, and wound onto a heat treatment roll unit to obtain the fiber.

It should be noted that the present invention is not limited to the above-described embodiments. Also, the present invention is not limited by the above-described functional advantages. Further, various modifications can be made to one or more embodiments of the present invention without departing from the scope of the present invention.

For example, in one or more embodiments, one or more undrawn filaments are drawn to obtain the fiber. Alternatively, in one or more embodiments, one or more undrawn filaments may be obtained as the fiber.

### Disclosure Items

The following items each disclose one or more embodiments.

### Item 1

A fiber including a core-sheath structure including a core portion and a sheath portion, wherein: each of the core portion and the sheath portion contains a poly(3-hydroxyalkanoate) resin including a 3-hydroxybutyrate unit; and an average molar content of the 3-hydroxybutyrate unit in the poly(3-hydroxyalkanoate) resin of the core portion is greater than an average molar content of the 3-hydroxybutyrate unit in the poly(3-hydroxyalkanoate) resin of the sheath portion.

### Item 2

The fiber according to item 1, including: a copolymer (A) in which a molar ratio of monomers of the 3-hydroxybutyrate unit to monomers of another hydroxyalkanoate unit is such that the 3-hydroxybutyrate unit/the other hydroxyalkanoate unit=from 99/1 to 93/7; and a copolymer (B) in which a molar ratio of monomers of the 3-hydroxybutyrate unit to monomers of another hydroxyalkanoate unit is such that the 3-hydroxybutyrate unit/the other hydroxyalkanoate unit=from 92/8 to 76/24.

### Item 3

The fiber according to item 2, wherein a content of the copolymer (B) in the fiber is from 5 to 40% by weight per 100% by weight of the poly(3-hydroxyalkanoate) resin.

### Item 4

The fiber according to item 2 or 3, wherein the sheath portion includes the copolymer (B).

### Item 5

The fiber according to item 4, wherein the sheath portion includes the copolymer (A) and the copolymer (B).

### Item 6

The fiber according to any one of items 1 to 5, wherein in a cross section of the fiber, an area ratio of the core portion to the sheath portion is such that the core portion/the sheath portion=from 8/2 to 2/8.

### Item 7

The fiber according to any one of items 1 to 6, wherein the poly(3-hydroxyalkanoate) resin is poly(3-hydroxybutyrate-co-3-hydroxyhexanoate).

### Item 8

The fiber according to any one of items 1 to 7, wherein a single filament fineness of the fiber is from 1 to 15 dtex.

### Item 9

A method for producing a fiber, the method comprising melt-spinning a raw material composition for the core portion and a raw material composition for the sheath portion by using a core-sheath composite spinning nozzle to obtain the fiber according to any one of items 1 to 8.

### Item 10

A nonwoven fabric including the fiber according to any one of items 1 to 8.

### EXAMPLES

Next, one or more embodiments of the present invention are described more specifically with Examples and Comparative Examples. It should be noted that the present invention is not limited by these Examples in any way.

Measurement and evaluation methods used in Examples and Comparative Examples are as described below.

### Example 1

First, materials listed below were subjected to dry blending at a blending ratio indicated below, and the resulting mixture was melt-kneaded at 150° C. by an extruder to obtain a raw material composition for a core portion and a raw material composition for a sheath portion each in the forms of pellets.

### <Raw Material Composition for Core Portion>

As a poly(3-hydroxyalkanoate) resin (copolymer (A)), a (3-hydroxybutyrate-co-3-hydroxyhexanoate) copolymer resin (with a molar content of the 3-hydroxybutyrate unit (3HB ratio) of 94.0 mol %, a molar content of the 3-hydroxyhexanoate unit (3HH ratio) of 6 mol %, a melting point of 145° C., a crystallization temperature (Tc) of 60° C., and a weight-average molecular weight (Mw) of 582,936) (P3HB3HH) (copolymer (A1)): 100 parts by mass
An erucic acid amide (EA) as an amide bond-containing lubricant: 0.5 parts by mass
A behenic acid amide (BA) as an amide bond-containing lubricant: 0.5 parts by mass
Pentaerythritol (PETL) as a crystal nucleating agent (Neulizer P available from The Nippon Synthetic Chemical Industry Co., Ltd.): 1.0 part by mass

### <Raw Material Composition for Sheath Portion>

As a poly(3-hydroxyalkanoate) resin (copolymer (A)), a (3-hydroxybutyrate-co-3-hydroxyhexanoate) copolymer resin (with a molar content of the 3-hydroxybutyrate unit (3HB ratio) of 94.0 mol %, a molar content of the 3-hydroxyhexanoate unit (3HH ratio) of 6 mol %, a melting point of 145° C., a crystallization temperature (Tc) of 60° C., and a weight-average molecular weight (Mw) of 582,936) (P3HB3HH) (copolymer (A1)): 50 parts by mass

As a poly(3-hydroxyalkanoate) resin (copolymer (B)), a (3-hydroxybutyrate-co-3-hydroxyhexanoate) copolymer resin (with a molar content of the 3-hydroxybutyrate unit (3HB ratio) of 89.0 mol %, a molar content of the 3-hydroxyhexanoate unit (3HH ratio) of 11.0 mol %, a melting point of 108° C., a crystallization temperature (Tc) of 60° C., and a weight-average molecular weight (Mw) of 582,936) (P3HB3HH) (copolymer (B1)): 50 parts by mass

An erucic acid amide (EA) as an amide bond-containing lubricant: 0.5 parts by mass

A behenic acid amide (BA) as an amide bond-containing lubricant: 0.5 parts by mass

Pentaerythritol (PETL) as a crystal nucleating agent (Neulizer P available from The Nippon Synthetic Chemical Industry Co., Ltd.): 1.0 part by mass

It should be noted that the molar content of the 3-hydroxybutyrate unit (3HB ratio), the molar content of the 3-hydroxyhexanoate unit (3HH ratio), and the weight-average molecular weight (Mw) were each determined by the above-described method.

On a DSC curve determined by differential scanning calorimetry (DSC), the melting point was defined as a temperature at which an endothermic energy amount was maximum (i.e., the apex of an endothermic peak).

The differential scanning calorimetry (DSC) is a method that accords with JIS K7122 (1987) “Testing Methods for Heat of Transitions of Plastics”.

Specifically, measurement was performed under the following conditions.
Equipment: Differential scanning calorimeter DSC6200 available from Seiko Instruments Inc.
Sample amount: 4 to 10 mg
Measurement temperature range: 30° C. to 200° C.
Temperature rise rate: 10° C./min

The crystallization temperature (Tc) was measured in accordance with JIS K7121-1987 “Testing Methods for Transition Temperatures of Plastics”.

Specifically, with use of a differential scanning calorimeter (e.g., Differential Scanning calorimeter DSC 25 available from TA Instruments), a sample of the poly(3-hydroxyalkanoate) resin in an amount of about 6.0 mg put in a measurement container was subjected to both heating and cooling at a heating rate of 10° C./min and a cooling rate of 10° C./min within a temperature range of −30° C. to 180° C. while flowing nitrogen gas at a flow rate of 50 ml/min. The peak top temperature of an exothermic peak when the sample was subjected to the cooling for the second time was determined as the crystallization temperature.

In a case where there were two or more exothermic peaks, the peak top temperature of the exothermic peak having the largest peak area among the two or more exothermic peaks was determined as the crystallization temperature.

### <Spinning Step>

Next, the raw material composition for the core portion in the form of pellets was fed to an extruder for the core portion, and the raw material composition for the sheath portion in the form of pellets was fed to an extruder for the sheath portion. Then, the raw material composition for the core portion and the raw material composition for the sheath portion were melted to obtain a molten material for the core portion and a molten material for the sheath portion.

Then, the molten material for the core portion and the molten material for the sheath portion were each extruded through a concentric circular core-sheath composite spinning nozzle (having 200 holes with a hole diameter of 0.5 mm) with a setting temperature of 175° C., and wound onto a winding roll unit at a speed of 250 to 300 m/min, thereby obtaining 200 undrawn filaments of a core-sheath conjugated fiber having an area ratio between the core portion and the sheath portion (core:sheath) in a cross section of 7:3 (this ratio is hereinafter also referred to as “core-sheath ratio”).

### <Core-Sheath Ratio>

At room temperature, the fibers were bundled together, and the fiber bundle (total fineness: 2200 dtex) was fixed with a shrinkable tube to prevent the fibers from shifting relative to each other. Thereafter, the fiber bundle was cut by a cutter into round cross sections, thereby preparing a fiber bundle for cross-sectional observation. An image of the fiber bundle was taken at a magnification of 500 times using a laser microscope (“VK-9500” available from KEYENCE CORPORATION) to obtain a fiber cross-sectional photograph, and the core-sheath ratio was determined based on the photograph.

### <Drawing Step>

The obtained 200 undrawn filaments were hauled off from the winding roll unit by a haul-off roll unit (at 55.5 m/min and 30° C.), drawn by a drawing roll unit (at 110 m/min and 90° C.), and wound onto a heat treatment roll unit (at 100 m/min). In this manner, a fiber (a multifilament including 200 single filaments, each being a core-sheath conjugated fiber having the sectional shape shown in the Figure) (with a single filament fineness of 5.5 dtex and a core-sheath ratio of 7:3) was obtained. The draw ratio was 2.0 times, and the relaxation rate was 10%.

It should be noted that each of the haul-off roll unit, the drawing roll unit, and the heat treatment roll unit used above includes two rolls that roll at the same speed and that have the same temperature.

### <Single Filament Fineness>

It should be noted that the single-filament fineness was measured using an auto-vibro type fineness measuring instrument (“DENIER COMPUTER Type DC-11” available from SEARCH CO., LTD). An average value of measurement values obtained from 10 samples was calculated and defined as the single-filament fineness.

### Example 2

A fiber (a multifilament including 200 single filaments, each being a core-sheath conjugated fiber) (with a single filament fineness of 6.1 dtex and a core-sheath ratio of 5:5) was obtained in the same manner as in Example 1 except that, in Example 2, the core-sheath ratio of the undrawn filaments was set to 5:5.

### Example 3

A fiber (a multifilament including 200 single filaments, each being a core-sheath conjugated fiber) (with a single filament fineness of 5.8 dtex) was obtained in the same manner as in Example 1 except that, in Example 3, the blending ratio of the raw material composition for the sheath portion was set as indicated below.

As a poly(3-hydroxyalkanoate) resin (copolymer (A)), a (3-hydroxybutyrate-co-3-hydroxyhexanoate) copolymer resin (with a content ratio of the 3-hydroxybutyrate unit of 94.0 mol %, a content ratio of the 3-hydroxyhexanoate unit of 6 mol %, a melting point of 145° C., a crystallization temperature (Tc) of 60° C., and a weight-average molecular weight (Mw) of 582,936) (P3HB3HH) (copolymer (A1)): 30 parts by mass

As a poly(3-hydroxyalkanoate) resin (copolymer (B)), a (3-hydroxybutyrate-co-3-hydroxyhexanoate) copolymer resin (with a content ratio of the 3-hydroxybutyrate unit of 89.0 mol %, a content ratio of the 3-hydroxyhexanoate unit of 11.0 mol %, a melting point of 108° C., a crystallization temperature (Tc) of 60° C., and a weight-average molecular weight (Mw) of 582,936) (P3HB3HH) (copolymer (B1)): 70 parts by mass

An erucic acid amide (EA) as an amide bond-containing lubricant: 0.5 parts by mass

A behenic acid amide (BA) as an amide bond-containing lubricant: 0.5 parts by mass

Pentaerythritol (PETL) as a crystal nucleating agent (Neulizer P available from The Nippon Synthetic Chemical Industry Co., Ltd.): 1.0 part by mass

### Example 4

A fiber (a multifilament including 200 single filaments, each being a core-sheath conjugated fiber) was obtained in the same manner as in Example 1 except that, in Example 4, the single filament fineness was set to 11.0 dtex.

### Example 5

A fiber (a multifilament including 200 single filaments, each being a core-sheath conjugated fiber) (with a single filament fineness of 4.5 dtex) was obtained in the same manner as in Example 1 except that, in Example 5, the blending ratio of the raw material composition for the core portion was set as indicated below; the blending ratio of the raw material composition for the sheath portion was set as indicated below; the core-sheath ratio of the undrawn filaments was set to 5:5; and the drawing step was not performed.

### <Raw Material Composition for Core Portion>

As a poly(3-hydroxyalkanoate) resin (copolymer (A)), a (3-hydroxybutyrate-co-3-hydroxyhexanoate) copolymer resin (with a molar content of the 3-hydroxybutyrate unit (3HB ratio) of 97.0 mol %, a molar content of the 3-hydroxyhexanoate unit (3HH ratio) of 3 mol %, a melting point of 152° C., a crystallization temperature (Tc) of 60° C., and a weight-average molecular weight (Mw) of 390,000 (P3HB3HH) (copolymer (A2)): 100 parts by mass

An erucic acid amide (EA) as an amide bond-containing lubricant: 0.5 parts by mass

A behenic acid amide (BA) as an amide bond-containing lubricant: 0.5 parts by mass

Pentaerythritol (PETL) as a crystal nucleating agent (Neulizer P available from The Nippon Synthetic Chemical Industry Co., Ltd.): 1.0 part by mass

### <Raw Material Composition for Sheath Portion>

As a poly(3-hydroxyalkanoate) resin (copolymer (A)), a (3-hydroxybutyrate-co-3-hydroxyhexanoate) copolymer resin (with a molar content of the 3-hydroxybutyrate unit (3HB ratio) of 94.0 mol %, a molar content of the 3-hydroxyhexanoate unit (3HH ratio) of 6 mol %, a melting point of 145° C., a crystallization temperature (Tc) of 60° C., and a weight-average molecular weight (Mw) of 582,936) (P3HB3HH) (copolymer (A1)): 50 parts by mass

As a poly(3-hydroxyalkanoate) resin (copolymer (B)), a (3-hydroxybutyrate-co-3-hydroxyhexanoate) copolymer resin (with a molar content of the 3-hydroxybutyrate unit (3HB ratio) of 89.0 mol %, a molar content of the 3-hydroxyhexanoate unit (3HH ratio) of 11.0 mol %, a melting point of 108° C., a crystallization temperature (Tc) of 60° C., and a weight-average molecular weight (Mw) of 220,000) (P3HB3HH) (copolymer (B2)): 50 parts by mass

An erucic acid amide (EA) as an amide bond-containing lubricant: 0.5 parts by mass

A behenic acid amide (BA) as an amide bond-containing lubricant: 0.5 parts by mass

Pentaerythritol (PETL) as a crystal nucleating agent (Neulizer P available from The Nippon Synthetic Chemical Industry Co., Ltd.): 1.0 part by mass

### Example 6

A fiber (a multifilament including 200 single filaments, each being a core-sheath conjugated fiber) (with a single filament fineness of 4.5 dtex) was obtained in the same manner as in Example 1 except that, in Example 6, the blending ratio of the raw material composition for the core portion was set as indicated below; the blending ratio of the raw material composition for the sheath portion was set the same as in Example 5; the core-sheath ratio of the undrawn filaments was set to 5:5; and the drawing step was not performed.

### <Raw Material Composition for Core Portion>

As a poly(3-hydroxyalkanoate) resin (copolymer (A)), a (3-hydroxybutyrate-co-3-hydroxyhexanoate) copolymer resin (with a molar content of the 3-hydroxybutyrate unit (3HB ratio) of 97.0 mol %, a molar content of the 3-hydroxyhexanoate unit (3HH ratio) of 3 mol %, a melting point of 152° C., a crystallization temperature (Tc) of 60° C., and a weight-average molecular weight (Mw) of 390,000 (P3HB3HH) (copolymer (A2)): 50 parts by mass

As a poly(3-hydroxyalkanoate) resin (copolymer (B)), a (3-hydroxybutyrate-co-3-hydroxyhexanoate) copolymer resin (with a molar content of the 3-hydroxybutyrate unit (3HB ratio) of 89.0 mol %, a molar content of the 3-hydroxyhexanoate unit (3HH ratio) of 11.0 mol %, a melting point of 108° C., a crystallization temperature (Tc) of 60° C., and a weight-average molecular weight (Mw) of 310,000 (P3HB3HH) (copolymer (B3)): 5 parts by mass

As a poly(3-hydroxyalkanoate) resin, a poly(3-hydroxybutyrate) homopolymer (P3HB) (with a melting point of 180° C., a crystallization temperature (Tc) of 60° C., and a weight-average molecular weight (Mw) of 310,000): 45 parts by mass

An erucic acid amide (EA) as an amide bond-containing lubricant: 0.5 parts by mass

A behenic acid amide (BA) as an amide bond-containing lubricant: 0.5 parts by mass

Pentaerythritol (PETL) as a crystal nucleating agent (Neulizer P available from The Nippon Synthetic Chemical Industry Co., Ltd.): 1.0 part by mass

### Comparative Example 1

A fiber (a multifilament including 200 single filaments, each being a core-sheath conjugated fiber) (with a single filament fineness of 5.6 dtex) was obtained in the same manner as in Example 1 except that, in Comparative Example 1, the blending ratio of the raw material composition for the sheath portion was set as indicated below.

As a poly(3-hydroxyalkanoate) resin (copolymer (A)), a (3-hydroxybutyrate-co-3-hydroxyhexanoate) copolymer resin (with a content ratio of the 3-hydroxybutyrate unit of 94.0 mol %, a content ratio of the 3-hydroxyhexanoate unit of 6 mol %, a melting point of 145° C., a crystallization temperature (Tc) of 60° C., and a weight-average molecular weight (Mw) of 582,936 (P3HB3HH)): 100 parts by mass

An erucic acid amide (EA) as an amide bond-containing lubricant: 0.5 parts by mass

A behenic acid amide (BA) as an amide bond-containing lubricant: 0.5 parts by mass

Pentaerythritol (PETL) as a crystal nucleating agent (Neulizer P available from The Nippon Synthetic Chemical Industry Co., Ltd.): 1.0 part by mass

### Comparative Example 2

A fiber (a multifilament including 400 single filaments each being a single-layer fiber) (with a single-filament fineness of 5.8 dtex) was obtained in the same manner as in Example 1 except that, in Comparative Example 2, only the raw material composition for the core portion of Example 1 was used; the concentric circular core-sheath composite spinning nozzle was not used; and a spinning nozzle intended for a single layer was used.

### Comparative Example 3

A fiber (a multifilament including 400 single filaments each being a single-layer fiber) (with a single-filament fineness of 6.0 dtex) was obtained in the same manner as in Example 1 except that, in Comparative Example 3, only the raw material composition for the sheath portion of Example 1 was used; the concentric circular core-sheath composite spinning nozzle was not used; and a spinning nozzle intended for a single layer was used.

### (Fusion Rate)

A fusion rate was determined in a manner described below.

First, the multifilament as the fiber was cut along a plane perpendicular to the longitudinal direction of the fiber, and thereby all the single filaments included in the fiber were cut.

Next, by using a scanning electron microscope (SEM), the cut surface of the multifilament was observed, and the total number of single filaments included in the multifilament was counted at the cut surface, and the number of single filaments fused to other single filaments at the cut surface (in other words, a number obtained by subtracting “the number of single filaments not fused to other single filaments” from “the total number of single filaments included in the multifilament”) was counted.

Then, the fusion rate was determined by using an equation shown below.

Fusion rate (%)=(the number of single filaments fused to other single filaments at the cut surface/the total number of single filaments included in the multifilament at the cut surface)×100

### (Thermal Fusion Temperature)

Eight fiber bundles each having a length of about 3 cm were cut out, and two sets of four fiber bundles were arranged in a grid pattern. The fiber bundles thus arranged were sandwiched between iron plates heated to 60 to 120° C., left to stand for 1 minute, and then removed. The temperature at which overlapping portions of the fiber bundles arranged in the grid pattern were fused together was defined as the thermal fusion temperature.

TABLE 1

| | | 3HH | 3HB | | | | | | | | | | |
|---|---|---|---|---|---|---|---|---|---|---|---|---|---|
| | | ratio | ratio | Melting | | | | | | | Comp. | Comp. | Comp. |
| | | (mol%) | (mol%) | point | Ex. 1 | Ex. 2 | Ex. 3 | Ex. 4 | Ex. 5 | Ex. 6 | Ex. 1 | Ex. 2 | Ex. 3 |
| Blending ratio | Copolymer (A1) | 6 | 94 | 145° C. | 100 | 100 | 100 | 100 | — | — | 100 | 100 | 0 |
| of core portion | Copolymer (A2) | 3 | 97 | 152° C. | — | — | — | — | 100 | 50 | — | — | — |
| (parts by | Copolymer (B3) | 11 | 89 | 108° C. | | | | | | 5 | | | |
| weight) | P3HB | 0 | 100 | 180° C. | — | — | — | — | — | 45 | — | — | — |
| | Erocic acid | — | — | — | 0.5 | 0.5 | 0.5 | 0.5 | 0.5 | 0.5 | 0.5 | 0.5 | — |
| | amide | | | | | | | | | | | | |
| | Behenic acid | — | — | — | 0.5 | 0.5 | 0.5 | 0.5 | 0.5 | 0.5 | 0.5 | 0.5 | — |
| | amide | | | | | | | | | | | | |
| | Pentaerythritol | — | — | — | 1.0 | 1.0 | 1.0 | 1.0 | 1.0 | 1.0 | 1.0 | 1.0 | — |
| Average molar content (mol %) of | | | | | 94.0 | 94.0 | 94.0 | 94.0 | 94.0 | 93.5 | 94.0 | 94.0 | — |
| 3HB in P3HA resin of core portion | | | | | | | | | | | | | |
| | Copolymer (A1) | 6 | 94 | 145° C. | 50 | 50 | 30 | 50 | 50 | 50 | 100 | 0 | 50 |
| | Copolymer (B1) | 11 | 89 | 108° C. | 50 | 50 | 70 | 50 | — | — | 0 | 0 | 50 |
| | Copolymer (B2) | 11 | 89 | 108° C. | — | — | — | — | 50 | 50 | — | — | — |
| | Erucic acid | — | — | — | 0.5 | 0.5 | 0.5 | 0.5 | 0.5 | 0.5 | 0.5 | — | 0.5 |
| | amide | | | | | | | | | | | | |
| | Behenic acid | — | — | — | 0.5 | 0.5 | 0.5 | 0.5 | 0.5 | 0.5 | 0.5 | — | 0.5 |
| | amide | | | | | | | | | | | | |
| | Pentaerythritol | — | — | — | 1.0 | 1.0 | 1.0 | 1.0 | 1.0 | 1.0 | 1.0 | — | 1.0 |

| | | | | | | | | | |
|---|---|---|---|---|---|---|---|---|---|
| Average molar content (mol %) of | 91.5 | 91.5 | 90.5 | 91.5 | 91.5 | 91.5 | 94.0 | — | 91.5 |
| 3HB in P3HA rexin of sheath portion | | | | | | | | | |
| Core-sheath ratio of fiber (core:sheath) | 7:3 | 5:5 | 7:3 | 7:3 | 5:5 | 5:5 | 7:3 | — | — |
| Single filament fineness (dtex) | 5.5 | 6.1 | 5.8 | 11.0 | 4.5 | 4.5 | 5.6 | 5.8 | 6.0 |
| Fusion rate (%) | 8.6 | 8.9 | 9.1 | 0.0 | 10.8 | 3.8 | 4.0 | 4.6 | 18.3 |
| Thermal fusion temperature (° C.) | 80 | 80 | 70 | 80 | 80 | 80 | 120 | 120 | 80 |
| Copolymer (B) content (wt %) per 100 wt % of P3HA rein. | 15 | 25 | 21 | 15 | 25 | 27.5 | 0 | 0 | 50 |
| Difference (mol %) between average molar content of | 2.5 | 2.5 | 3.5 | 2.5 | 2.5 | 2.0 | 0.0 | — | — |
| 3HB in P3HA resin of core portion and average molar | | | | | | | | | |
| content of 3HB in P3HA rexin of sheath portion | | | | | | | | | |

As shown in Table 1, the thermal fusion temperatures in Examples 1 to 6, which fall within the scope of the present invention, were lower than those in Comparative Example 1 (poly(3-hydroxyalkanoate) resin: copolymer (A) only), in which the average molar content of the 3-hydroxybutyrate unit was the same in the core portion and the sheath portion, and Comparative Example 2 (poly(3-hydroxyalkanoate) resin: copolymer (A) only), in which the fiber did not have a core-sheath structure.

Further, the fusion rates in Examples 1 to 6, which fall within the scope of the present invention, were lower than the fusion rate in Comparative Example 3 (poly(3-hydroxyalkanoate) resin: copolymer (A) and copolymer (B)), in which the fiber did not have a core-sheath structure.

Therefore, it is understood that one or more embodiments of the present invention makes it possible to provide a poly(3-hydroxyalkanoate) resin-containing fiber in which the poly(3-hydroxyalkanoate) resin includes a 3-hydroxybutyrate unit, the fiber being suppressed from fusing during production of the fiber and being thermally fusible at low temperatures during thermal processing of the fiber.

### REFERENCE SIGNS LIST

1: single filament, 10: core portion, 20: sheath portion

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A fiber comprising a core-sheath structure comprising a core portion and a sheath portion, wherein:
each of the core portion and the sheath portion comprises a poly(3-hydroxyalkanoate) resin comprising a 3-hydroxybutyrate unit; and
an average molar content of the 3-hydroxybutyrate unit in the poly(3-hydroxyalkanoate) resin of the core portion is greater than an average molar content of the 3-hydroxybutyrate unit in the poly(3-hydroxyalkanoate) resin of the sheath portion.

2. The fiber according to claim 1, wherein the fiber comprising the core-sheath structure comprises:
a copolymer (A) having a molar ratio of monomers of the 3-hydroxybutyrate unit to monomers of another hydroxyalkanoate unit in a range of from 99/1 to 93/7; and
a copolymer (B) having a molar ratio of monomers of the 3-hydroxybutyrate unit to monomers of another hydroxyalkanoate unit in a range of from 92/8 to 76/24.

3. The fiber according to claim 2, wherein a content of the copolymer (B) in the fiber is from 5 to 40% by weight per 100% by weight of the poly(3-hydroxyalkanoate) resin.

4. The fiber according to claim 2, wherein the sheath portion comprises the copolymer (B).

5. The fiber according to claim 4, wherein the sheath portion further comprises the copolymer (A).

6. The fiber according to claim 1, wherein in a cross section of the fiber, an area ratio of the core portion to the sheath portion is in a range of from 8/2 to 2/8.

7. The fiber according to claim 1, wherein the poly(3-hydroxyalkanoate) resin is poly(3-hydroxybutyrate-co-3-hydroxyhexanoate).

8. The fiber according to claim 1, wherein a single filament fineness of the fiber is in a range of from 1 dtex to 15 dtex.

9. A method for producing the fiber according to claim 1, the method comprising melt-spinning a raw material composition for the core portion and a raw material composition for the sheath portion through a core-sheath composite spinning nozzle to obtain the fiber.

10. A nonwoven fabric comprising the fiber according to claim 1.
